(19) United States
(12) Patent Application Publication
(10) Pub. No.: US 2025/0321153 A1
(43) Pub. Date: Oct. 16, 2025

(54) MACHINE LEARNING-BASED MULTIVARIATE SENSING APPARATUS AND METHOD FOR LEAK DETECTION

(71) Applicant: Shoreline AI, Inc., Los Gatos, CA (US)

(72) Inventor: Mark Stubbs, Felton, CA (US)

(73) Assignee: Shoreline AI, Inc., Los Gatos, CA (US)

(21) Appl. No.: 18/637,341

(22) Filed: Apr. 16, 2024

(51) Int. Cl. G01M 3/24; G06N 20/00; H04L 67/12

(52) U.S. Cl. CPC G01M 3/24; G06N 20/00; H04L 67/12

(57) ABSTRACT

A multivariate sensing device is to be coupled to a containment asset designed to contain a pressurized fluid, the multivariate sensing device comprising: sensors to provide sensor data, circuitry to implement a local ML engine operable in accordance with a first ML model to detect leaks of the pressurized fluid from the containment asset based on the sensor data; a wireless interface to couple the multivariate sensing device to a cloud ML engine operable in accordance with a second ML model to detect leaks of the pressurize fluid with greater accuracy, the multivariate sensing device to transmit a first message via the wireless interface to the cloud-based management service in response to a detected leak, the cloud ML engine to determine if the sensor data indicates a leak and, if not, then the cloud-based management service is to transmit a message to the multivariate sensing device for additional training.

### BACKGROUND

### Field of the Invention

This invention relates generally to the field of computer systems. More particularly, the invention relates to a machine learning-based multivariate sensing apparatus and method for leak detection.

### Description of the Related Art

In general, “Internet of Things” is a network of identifiable, purposed “things” that are enabled to communicate data over a communications network, such that the communicated data may at least in part form a basis for controlling, modifying, or maintaining the operation of the “things.” Generally speaking, an asset becomes a “thing” when the asset is equipped with one or more sensors capable of capturing one or more types of data pertaining to asset.

Artificial intelligence of things (“AIoT”) devices are a particular category of IoT devices which rely on trained machine learning models to recognize particular types of events or conditions. For example, AIoT devices trained to perform anomaly detection recognize conditions which deviate from “normal” operating or environmental conditions. The AIoT device may be configured to perform various actions in response to detecting anomalies, such as recording to a log file, altering users, and/or initiating control operations.

Industrial IoT (IIoT) devices are IoT devices used to monitor industrial processes, devices, and critical infrastructure, and perform control functions to control industrial machines on manufacturing floors and power distribution systems. IIoT devices are used in various industries including manufacturing, oil and gas, power generation, aviation, maritime, rail, and utilities, to name a few.

The leakage of gas and liquids from containment devices is a particularly costly and dangerous problem experienced in various industrial systems. Most gas leak detection technologies on the market today utilize direct measurements of methane or other volatile organic compounds to determine when a leak is present. To perform these measurements, special cameras, lidar, metal oxide sensors, or other technologies are used to directly detect the presence of the gas.

Given the array of different sensors required, these devices are extremely costly and impractical for a wide range of applications. Additionally, current gas leak detection devices consume power at a level which makes them impractical for remote installations where battery power is required. In addition, existing devices are challenging to install and configure (often requiring a trained installer) and often require frequent maintenance. The sensors often comprise complex hardware, require specialized network connectivity such as proprietary gateway architectures and connections, and dedicated power connections. Some sensors that rely on battery power rather than a dedicated power connection require frequent battery changes, thereby requiring continual costly maintenance.

Additionally, existing “fenceline monitoring” solutions place sensors around the fence line of a gas plant to detect fugitive emissions from equipment. However, these solutions are incapable of pinpointing the location and source of leaks with reasonable precision, resulting in undetected leaks from above ground assets (e.g., storage tank thief hatch leaks). Furthermore, fenceline monitoring solutions are notoriously expensive and do not scale across 1000s of sites and assets (e.g., particularly those outside of the plant fence line).

### BRIEF DESCRIPTION OF THE DRAWINGS

A better understanding of the present invention can be obtained from the following detailed description in conjunction with the following drawings, in which:

FIG. 1 illustrates an example portion of an oil/gas collection and distribution system on which embodiments of the invention are implemented.

FIG. 2 illustrates a multivariate sensing device coupled to a storage tank in accordance with some embodiments.

FIG. 3 illustrates details of an example embodiment of a multivariate sensing device.

FIG. 4 illustrates machine learning engines in a multivariate sensing device and a cloud service in accordance with some embodiments.

FIG. 5 illustrates a method in accordance with embodiments of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

Embodiments of the invention address the above-described problems using multivariate sensing in combination with machine learning based on properties of the escaping gas and the containment device. In contrast to existing implementations, these embodiments reliably determine occurrences of gas leaks without directly measuring the type or quantity of gas escaping. By way of example, and not limitation, the sensors used in some implementations include temperature sensors, conducted vibration sensors (e.g., accelerometers), conducted sound/ultrasound sensors, and/or airborne sound sensors, some of which are described in detail below. Using multivariate sensing, embodiments of the invention provide a more effective mechanism to indirectly detect the presence of a gas leak at significantly lower cost than existing implementations. These embodiments also significantly reduce maintenance costs, given that the sensors which directly measure escaping gas in existing systems (e.g., metal oxide sensors) wear out and must frequently be replaced. Additionally, the embodiments described herein can be used in battery-powered devices, making them practical for remote applications.

While specific examples are provided below in the context of oil and gas pipelines, embodiments of the invention may be used in any system in which pressurized fluids are stored and/or distributed including, by way of example and not limitation, bio gas plants, water/wastewater tanks, and chemical plants. For example, the multivariate sensing devices described herein may be trained to detect leakage of toxic gasses from chemical plants, such as ethylene oxide and chloroprene. Moreover, while certain examples below are implemented on gas storage tanks, embodiments of the invention can be trained via machine learning to identify gas leakage from any hardware component within a gas distribution or storage system including, for example, pipes, tanks, valves, or any other hardware where gas leaks are to be monitored (e.g., compressors, process controllers and pumps, storage vessels, sweetening units, etc).

Moreover, embodiments described herein are capable of detecting leaks generated by a variety of conditions including, but not limited to, improper or loose fittings and connections, damaged valves, corroded or damaged gates or plug seats in valves (which prevent tight closure), worn valve stem seals, damaged equipment, worn/damaged gaskets, and human error (e.g., components such as valves or thief hatches are inadvertently left open).

### Introduction

Existing oil and gas distribution and processing systems require a large and complex network of operational components. As a brief overview, a well site is the physical location at which oil and gas wells are drilled and oil and/or natural gas are produced. Natural gas collected from the well site is distributed to one or more intermediate stations which compress the gas at various pressure levels to separate the gas from other components. These intermediate stations can include, for example, gathering compressor stations, each of which receives the natural gas via a pipeline directly from the well site or from another compressor station. Gathering compressor stations may compress the gas to a specified pressure (e.g., between 500 and 1000 psi) and before distributing it further along the pipeline for processing at a natural gas plant or another compressor station. The natural gas plant includes specialized equipment to drop the pressure/temperature (e.g., to cryogenic levels in some implementations) to condense natural gas liquids, which are then separated out. Natural gas plants may also compress the gas on-site prior to further distribution. The compressed gas is distributed from the natural gas plant to one or more transmission compressor stations, which store the gas in a compressed state at a location from which the gas is distributed for use (e.g., by a city or large industrial customer).

Adjusting the pressure and temperature at various stages of the system allows other components of the gas stream to be separated out, such as oil, wastewater, and other hydrocarbons, which can be stored off to a separate storage tank (e.g., a “slop tank”) and subsequently collected. These storage tanks are generally pressurized to 10-11 psi above atmospheric pressure and are equipped with pressure relief valves (PRVs) or pressure safety valves (PSVs) to ensure safe pressure thresholds are not exceeded. In the case of a PSV, when the pressure exceeds the valve spring force, the valve fully opens, thereby dramatically dropping the pressure. In contrast, a PRV opens by an amount which is proportional to the increasing pressure, resulting in a relatively gradual pressure reduction as compared to PSV. In either case, when the pressure of the storage tank exceeds a threshold, the corresponding valve is triggered, resulting in the leakage of significant amounts of valuable hydrocarbons into the atmosphere.

Additionally, gas leaks can occur through malfunctioning packing glands or stuffing boxes in dual acting reciprocating compressors which are designed to prevent the escape of gasses when the piston is drawn back on the compression cycle towards the crankshaft. This stuffing/seal wears over time and, if not detected, can result in significant methane loss from a compressor. The gas may also be vented to the crankcase and plumbed to the slop tank where it quickly overwhelms the capacity of the tank, triggering a pressure relief valve or pressure safety valve.

### Embodiments of a Multivariate Sensing Apparatus

Embodiments of the invention described herein are capable of sensing the distinctive sounds, temperatures, and vibrational patterns associated with different types of leaks and may be configured at various stages along the processing pipeline where pressure and temperature are adjusted (e.g., gathering compressor stations, transmission compressor stations, slop tanks, and within natural gas plants). These embodiments capture measurements from a plurality of different sensor types to learn (through training) and subsequently identify signatures comprising combinations of sensor readings which indicate a gas leak in a variety of contexts.

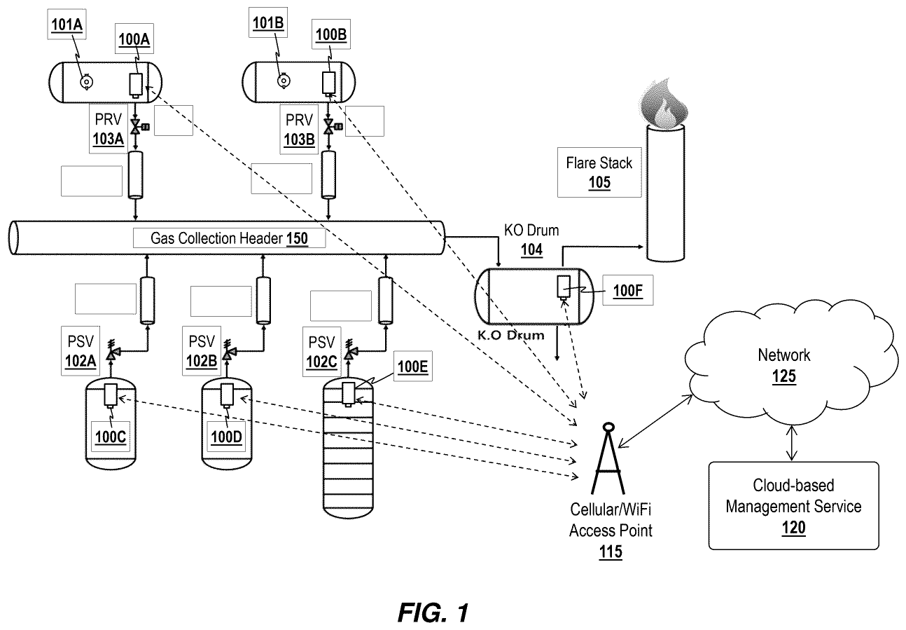

FIG. 1 illustrates an example in which multivariate sensing devices 100A-F in accordance with embodiments of the invention are coupled to different types of storage tanks within a distribution and processing system. Certain tanks are shown equipped with pressure release valves 103A-B which perform a relatively gradual pressure reduction in response to overpressure conditions. Other tanks are equipped with pressure safety valves (PSVs) 102A-C configured to fully open when pressure exceeds the valve spring force. The various tanks are coupled to a gas collection header 150 which transfers released gas to a knockout drum 104 designed to remove condensed and entrained liquids from the relief gases. A flare stack 105 coupled to the knockout drum 104 is a vertical stack used for burning off unusable waste gas or flammable gas and liquids released by the tanks during unplanned over-pressuring of plant equipment.

Thief hatches 101A-B may also be included on certain tanks to provide immediate depressurization when a pressure threshold is reached. For example, thief hatches 101A-B may have either a spring-loaded assembly which pops at a given pressure (PSI), or a gravity/weight based system which pops under a given pressure. The thief hatch on a slop tank, for example, pops open and vents pressure when the slop tank exceeds a configured pressure setpoint.

Various embodiments of the multivariate sensing devices 100A-F include wireless transceivers capable of communicating over different types of wireless channels including Bluetooth channels (e.g., Bluetooth Low Energy (BTLE) channels), cellular data communication channels, WiFi channels, and radio frequency ID (RFID) channels (e.g., such as near field communication (NFC) channels). In the illustrated example, a cellular or WiFi access point 115 couples the multivariate sensing devices 100A-F to a cloud-based management service 120 via a network 125 (e.g., a private network and/or public network such as the Internet).

As described further below, the multivariate sensing devices 100A-F are registered and provisioned to communicate with and utilize services provided by the cloud-based management service 120. For example, in some embodiments, a combination of sensor data is used by local machine-learning engines with models operating on each multivariate sensing device 100A-F to determine if a leak has occurred. The local machine-learning engines are designed to operate at relatively low power, given that at least some of the multivariate sensing devices 100A-F operate on battery power only. If one of the local machine learning models detects a leak, it transmits a message including the sensor data to the cloud-based management service 120, which runs a more powerful machine-learning model, trained with data from a plurality of multivariate sensing devices distributed across the system. If the leak is confirmed, the cloud-based management service 120 triggers notifications (e.g., sending text/email messages to relevant users and/or generating alerts on monitoring consoles) and, in some implementation, may transmit control messages to automatically perform actions in an attempt to alleviate the problem. If the machine-learning model running on the cloud-based management service 120 determines that no leak has occurred, then in some embodiments it will provide information for additional training of the local machine learning model which detected the leak. In some embodiments, for example, a message may be transmitted to the respective multivariate sensing device 100A-F that the sensor data provided dies not indicate a leak. The multivariate sensing device 100A-F can then use this indication in combination with the sensor data to perform additional training of its local model.

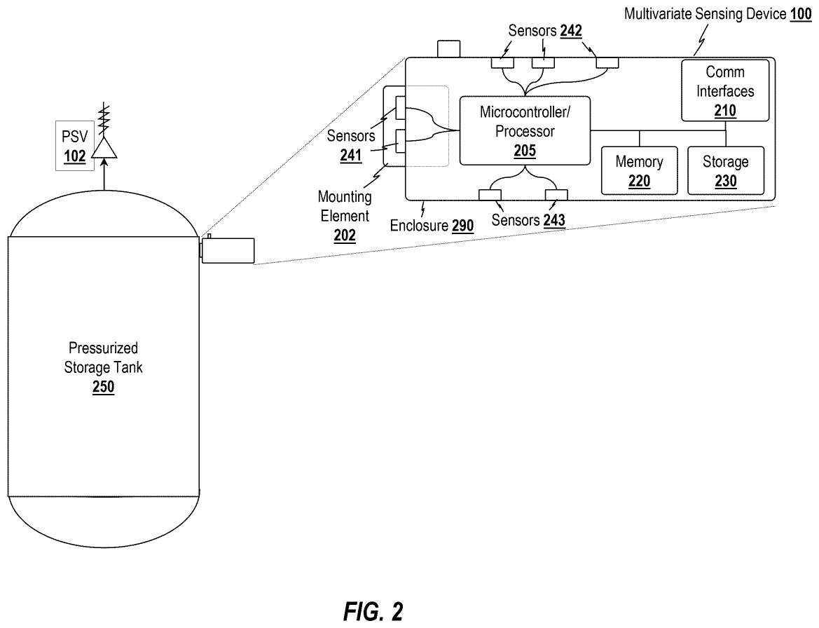

FIG. 2 illustrates an example with a multivariate sensing device 100 and a pressurized storage tank 250 equipped with a PSV 102. In this embodiment, the multivariate sensing device 100 includes a microcontroller/processor 205 coupled via an interconnect to a memory 220 and/or storage device 230 for storing program code and data, and one or more communication interfaces 210 for establishing wireless communication channels to a service (e.g., such as the cloud-based service 120). Examples of these components are described below.

As illustrated, a mounting element 202 exposed through an opening in the enclosure 290 of the multivariate sensing device 100 (or formed on the enclosure) is affixed to the outer surface of the pressurized storage tank 250. While shown affixed to a storage tank 250 in FIG. 2, the multivariate sensing device 100 may be affixed via the mounting element 202 to any hardware within the gas distribution system including, for example, pipes, tanks, valves, or any other hardware where gas leaks are to be monitored.

An adhesive may be used to couple the mounting element 202 and tank 250 (e.g., such as a two-part adhesive consisting of an epoxy resin and a hardener), although the connection may be formed in other ways while still complying with the underlying principles of the invention (e.g., using a magnetic connection, clamps, connection brackets, straps, etc). In one particular embodiment, the mounting element 202 is formed from stainless steel (e.g., 316 stainless steel) and includes one or more sensors 241 integrated within it or adjacent to it. Other sensors 242-243 may be exposed through openings in the enclosure 290 at different locations or may be enclosed within the enclosure (depending on the type of sensor).

The sensors 241-243, by way of example and not limitation, may include one or more of: a triaxial accelerometer to capture vibration through the mounting element 202, a surface ultrasonic microphone, an airborne microphone, a surface temperature sensor, an environmental temperature sensor, and a humidity sensor. The sensors 241-243 take measurements periodically and/or in response to events/triggers and provide the measurements to the microcontroller/processor 205 (potentially first storing the measurements to a region in memory 220 and/or the storage device 230). As described further below, in some embodiments, a trained machine-learning (ML) model is executed by the microcontroller/processor 205 to detect leaks based on combinations of measurements captured by the sensors 241-243. The ML model is trained to recognize different combinations of measured data from different types of sensors may be recognized by the ML model as signatures of a gas leak. Alternatively, or additionally, the cloud-based management service 120 may execute a trained ML model to detect leaks based on sensor data provided from the multivariate sensing device 100.

If an ML model detects a gas leak based on the sensor measurements, the cloud-based management service 120 may verify the detection result (e.g., by running its machine learning model on the sensor measurements) and generate notifications/alerts to inform one or more users of potential leaks in the system (e.g., the users responsible for ensuring proper operation of the system). The notifications may include, for example, an indication of the collected data, an indication of the likelihood of a leak (e.g., based on the confidence of the ML model that a leak has occurred), and a location corresponding to the multivariate sensing device 100 which captured the corresponding measurements. The user can then request additional measurement data or physically visit the location to investigate the problem.

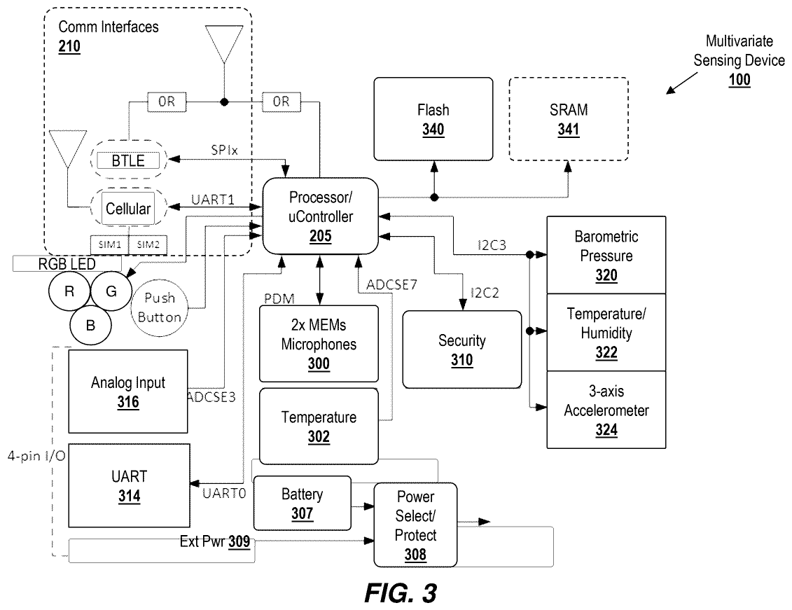

FIG. 3 illustrates additional details of one embodiment of a multivariate sensing device 100. The processor/microcontroller 205 (hereinafter simply referred to as a “processor”) comprises an ultra low power embedded processor such as an ARM M4F (e.g., such as an Apollo3 Blue from Ambiq). However, the underlying principles of the invention are not limited to any particular processor type. The processor 205 is coupled over one or more interconnects to the to the wireless communication interfaces 210 (e.g., BTLE and cellular via a system peripheral interface (SPIx) and universal asynchronous receiver-transmitter (UART) interface, respectively), to a flash memory device 240, and/or to an optional static dynamic random access memory (SRAM) device 341. In some implementations, these components are all integrated within a single SoC chip (e.g., such as the Apollo 3. Blue).

In some embodiments, the wireless communication interfaces 210 include an LTE-M/NB cellular modem for communication with the Cloud-based management service 120 via network 125. In addition, a short range wireless interface such as a Bluetooth Low Energy (BTLE) interface/microcontroller unit (MCU) is included to allow connections from a mobile phone or other device to allow provisioning and/or configuration from a mobile phone (e.g., running a management app) and to support local communication with other multivariate sensing devices within range. Other short range wireless technologies may also be used including, but not limited to, RFID/NFC and WiFi. In some implementations, the short range wireless interface is also used as an alternate or backup communication channel with the cloud-based management service 120 (e.g., by establishing communication via a local mobile device).

The various sensors described herein may be coupled to the processor 205 over one or more interconnects which can include, for example, I²C interconnects, SPI interconnects, and/or PCIe interconnects. In some implementations, the sensors are directly coupled to a sensor hub which includes circuitry for performing digital-to-analog conversions to convert analog values to digital values and interface circuitry to couple the sensor hub to the processor 205 via the one or more interconnects. In the illustrated embodiment, the sensors include a barometric pressure sensor 320, a temperature/humidity sensor 322, a 3-axis accelerometer 324, a temperature sensor 302 (e.g., an LMT84 CMOS temperature sensor), dual MEMs (microelectromechanical systems) microphones 300, a UART input/output port 314 (with a 0-24V digital input) and an analog input port 316 (e.g., a 4-20 ma, 0-10V analog signal input up to 2 kHz). In some embodiments, the 3-axis accelerometer 324 is a conducted vibration sensor which is capable of measuring high and low frequency shaking in three dimensions. In these implementations, the different types of sensors are selected so that the collected data can be used to accurately differentiate between a leak condition from other environmental conditions.

In some implementations, a first of the dual MEMs microphones 300 is integral within or in proximity to the mounting element 202 (e.g., one of sensors 241) and a second of the microphones is located further away from the mounting element 202 and configured to capture sound from the air surrounding the enclosure 290 (e.g., one of sensors 242). Separate measurements may be captured from each microphone to perform differential calculations to filter out unwanted noise from the measurements.

A dedicated security processor/circuit 310 is coupled to the processor 205 to perform various authentication and security operations. In one embodiment, the security processor/circuit 300 implements the ECDH (Elliptic Curve Diffie Hellman) security protocol to provide key agreement for encryption/decryption and the ECDSA (Elliptic Curve Digital Signature Algorithm) protocol for sign-verify authentication. In some implementations, all wireless communication between each multivariate sensing device 100 and the cloud-based management service 120 (and mobile devices) is encrypted and/or protected via authentication using signatures. In these embodiments, the security circuitry 310 is part of a larger security subsystem which allows the multivariate sensing device 100 to establish a secure communication channel with the cloud-based management service 120 to transfer messages, including detection results and sensor data, and to receive messages, such as notifications and commands. For example, in some embodiments described further below, when the ML model running on a multivariate sensing device 100 detects a leak but the ML model running on the cloud-based management service 120 determines there is no leak after evaluating the sensor data, the cloud-based management service 120 may transmit the result and/or supplemental information in a message which the multivariate sensing device 100 can use for additional training of its ML model.

The illustrated implementation includes an internal battery 307 and includes a power input for an external power source 309, which may be a larger external battery or a direct power supply (e.g., a 9-24 VDC power input). In some embodiments, the internal batteries 307 and/or external batteries (if used) are long life primary cell lithium batteries.

As mentioned, machine learning may be performed on the individual multivariate sensing devices 100 and/or on the cloud-based management service 120. In these embodiments, the initial machine learning models may initially be seeded from a physics model of the environment in which the multivariate sensing devices are used. In addition, transfer learning may be used using previously installed devices. For example, a ML model trained for a first multivariate sensing device in a first environment may be used as a starting point for an initial model in a second multivariate sensing device in a second environment which is similar to the first environment (e.g., where both the first and second devices are used on the same type of storage tank). Once the initial ML model is installed and the corresponding multivariate sensing device coupled to its location, the initial ML model may be trained via an initial training process and subsequently trained based on feedback received from users and/or the cloud-based management service 120. For example, if it generates a false positive alarm for a leak, a user may provide feedback (e.g., via an app on a mobile device) indicating that there was no leak. Similarly, the cloud-based management service 120 may transmit a message indicating that the sensor data indicates no leak. In either or both cases, the multivariate sensing device 100 uses the feedback to train and improve the accuracy of its ML model.

During an initial or subsequent training process, various ranges of sensor data may be fed into the ML model with an indication as to whether the combined sensor data indicates a gas leak. Sensor data for actual gas leaks may also be collected and used during the training process (e.g., indicating to the ML model when combinations of measured values are associated with gas leaks and when they are not). When the ML model is sufficiently trained, it is capable of distinguishing between gas leaks and other environmental events and conditions not directly associated with gas leaks. Given the different potential environmental conditions, the ML model for each multivariate sensing device 100 may be individually trained based on its installed environment.

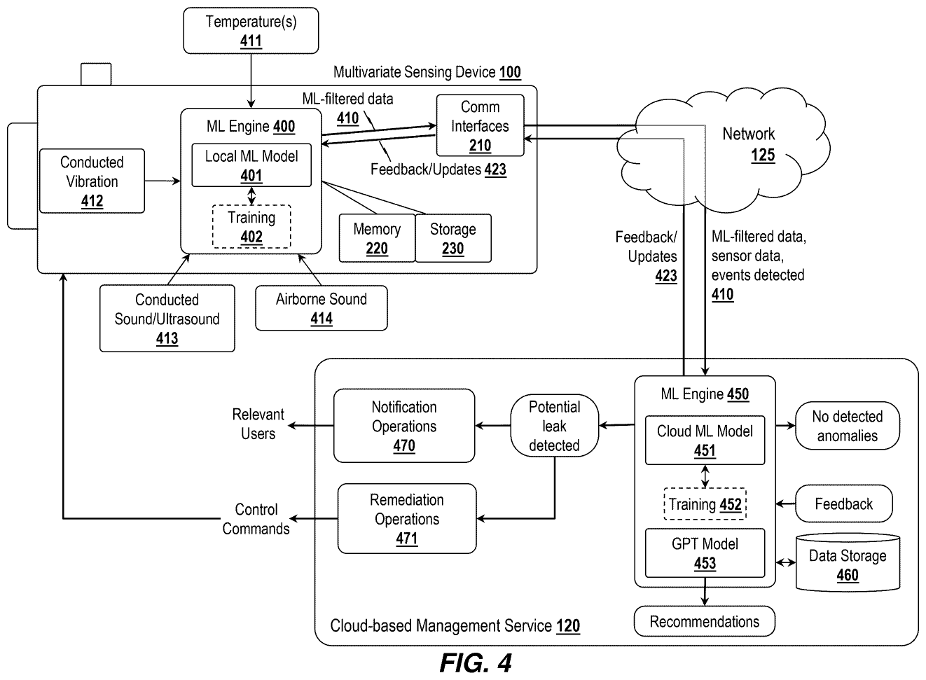

FIG. 4 illustrates one example in which an ML engine 400 running a local ML model 401 in the multivariate sensing device 100 combines measurements data from sensors including, for example, temperature 411, conducted sound/ultrasound 413, conducted vibration 412, and airborne sound 414 to infer the presence of measurements which indicate a leak is present from the tank, valve, pipe, or other hardware of the system. As mentioned, in one embodiment, the local ML model 401 is relatively lightweight model which does not require a significant amount of power (e.g., processor and memory resources) to accurately detect leaks once trained. Local ML models 401 may be trained on data from assets which are operating normally and ones in which leaks have occurred to provide an accurate supervised model which reliably detects the presence of a leak.

A machine learning engine 450 operating with a cloud ML model 451 on the cloud-based management service 120 operates in a similar manner to compare historical trends and the current sensor data to confirm and classify the leak detected. Because the cloud-base management service 120 has significantly greater processing resources and power, the cloud model 451 may be more complex and more accurate, allowing for a comparison of a wider range of features in the measured data, such as the detailed signatures produced by the accelerometer 324 and microphones 300 as well as the temperature trends from temperature sensors 322, 302.

In these embodiments, the local model 401 performs leak detection using lower power—particularly in cases where the battery 307, 309 is the only source of power and/or when the multivariate sensing device 100 is in a remote location. Blindly uploading all sensor data to the cloud-based management service 120 would consume significant power as the wireless interface(s) 210 (e.g., cellular modem) needs to be active for uploads. Thus, in some embodiments, the lightweight detection performed by the ML engine 400 running the local model 401 allows most of the samples collected from the sensors to be ignored (e.g., those which do not have any matching features for a leak) and only the resulting ML-filtered data 410 is transmitted to the cloud-based management service 120 for further evaluation.

Once the ML-filtered data 410 is received, the ML engine 450 using the cloud ML model 451 improves on the lightweight sensor model by tracking real (positive reinforcement) and false (negative reinforcement) alarms. These may incorporate various combinations of sound, temperature, and vibration data as previously described. This allows the individual local models 401 to be retrained via local training logic 402 and optimized to behave properly for the asset being monitored based on feedback/updates 432 provided from the cloud ML engine 450. The local models 401 may be updated wirelessly (e.g., via the communication interfaces 210) or through the regular maintenance process (e.g., updating from a local connection when the batteries 307, 309 are swapped out). Retraining and optimizing the initial local model 401 for a specific asset allows the corresponding ML model 401 at the edge to improve over time, helping to further conserve power and improve detection accuracy.

Feedback from users may also be collected and used to retrain the cloud model 451 via training logic 452 and local models 401 via local training logic 402. For example, when a potential leak is detected by the cloud-based management service 120, notification operations 470 such as alarms may be generated and communicated via email messages, text messages, and/or notifications on a management console. When a user investigates and determines the alarm is false, they may provide feedback and note what was actually observed.

In some embodiments, this feedback may be processed using natural language processing (NLP) and recorded in a log within a data storage device 460 to help improve the detection of the models 401, 451. When an alarm is fixed, the fix reason is recorded and processed using NLP and stored in the record in the data store 460. This allows the use of a generative pre-trained transformer (GPT) model 453 to train a virtual expert which may be used to provide suggestions on what action the next field technician may take based on previous failure signatures. Over time, the GPT model 453 will be capable of combining the signatures observed, comparing them to previous signatures, and generating improved recommendations based on the specific asset's previous history (which may be stored in the cloud data storage device 460). This improves the accuracy of the recommended action and informs technicians who can take the parts needed to the field and quickly repair the problem.

In some embodiments, the ML engine 450 may also generate messages for remediation operations 471, such as control commands transmitted to the location of the leak to implement one or more control functions. For example, some embodiments of the multivariate sensing device 100 or a separate control device coupled to the cloud-based management service 120 can perform control functions to temporarily prevent further leakage (e.g., such as temporarily alleviating the pressure in the affected tank by distributing the gas to one or more other storage facilities within the system).

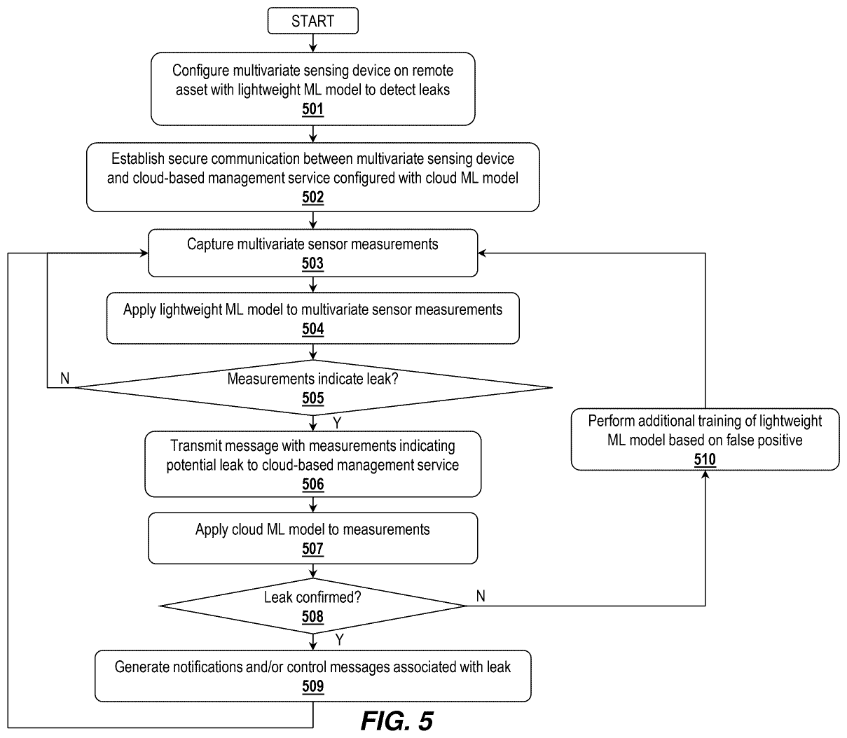

A method in accordance with some embodiments is illustrated in FIG. 5. The method may be implemented on the various architectures described herein, but is not limited to any particular device or system architecture.

At 501, a multivariate sensing device is configured on a containment asset (e.g., a gas storage tank) with a lightweight ML model to detect leaks. As mentioned, the initial lightweight ML model may be seeded from a physics model of the environment in which the multivariate sensing device is used and/or transfer learning may be performed using ML models from similarly configured multivariate sensing devices. A lightweight ML model is used to conserve power on the multivariate sensing device, which may rely on battery power and/or may be in a remote location.

At 502, a secure communication channel is established between the multivariate sensing device and a cloud-based management service configured with cloud ML model. This may be part of a provisioning operation conducted by an authorized user running an app on a mobile device, or using a dedicated provisioning device.

At 503, multivariate sensor measurements are captured from a plurality of different sensor types. Example sensor data may include temperature, conducted sound/ultrasound, conducted vibration, and airborne sound.

At 504, the lightweight ML model is applied to the multivariate sensor measurements. Based on its training, the lightweight ML model may infer from certain combinations of measurements that a leak has occurred in the asset being monitored (e.g., the tank, valve, or pipe). For example, the inference may be based on a particular vibrational pattern detected from the conducted vibration, in combination with a particular temperature, sound/ultrasound, and/or airborne sounds.

If the lightweight ML model infers a leak (or a potential leak) based on the measurements, determined at 505, then at 506 the multivariate sensing device transmits a message (or message sequence) to the cloud-based management service. The message may include an indication of the potential leak, identification information to identify the location of the multivariate sensing device (e.g., using a UUID, device name, MAC address, and/or other forms of identification information), information related to the asset being monitored (e.g., the device type, identifier, and/or geographic location), a confidence score (e.g., the likelihood of a leak based on the sensor measurements), and/or the underlying sensor measurements.

At 507, the cloud-based management service applies a cloud ML model to the sensor data and related information (e.g., such as the asset type) to generate a result. As mentioned, because the cloud service is not power-limited, the cloud ML model can be implemented with processor-intensive and memory-intensive operations to produce a more accurate result than the result produced by the lightweight ML model.

If a leak is confirmed, determined at 508, then at 509, the cloud-based management service may generate various notifications and/or control messages associated with the detected leak. For example, email/text messages may automatically be sent to relevant users and alerts may be generated on corresponding administrative consoles. In addition, some embodiments allow automatic control operations to be performed in response to the leak detection. For example, the cloud-based management service may automatically transmit control messages to alleviate the pressure associated with the asset (e.g., such as offloading gas from the storage device to other storage devices).

If the leak is not confirmed at 508, then at 510 additional training of the lightweight ML model may be performed based on the false positive. For example, the multivariate sensing device may be notified that the set of sensor readings which it identified as a leak, was not a leak. The lightweight ML model may then be updated through training which associates this particular set of sensor readings (and related variables) with a no leak condition.

The leakage of gas and liquids from containment devices is a particularly costly and dangerous problem experienced in various industrial systems. Embodiments of the invention directly address this problem with greater accuracy, lower maintenance, and at significantly lower cost than existing implementations.

Embodiments of the invention may operate with various types of machine learning models other than those specifically described herein. These may include, for example, deep learning techniques, training, and classifiers such as Naive Bayes (NB), Support Vector Machines (SVM), Deep Neural Networks (DNNs), Convolutional Neural Networks (CNNs) and likelihood estimation models such as Gaussian Mixture Models (GMMs), Hidden Markov Models (HMMs), and AutoRegressive Neural Networks, as well as digital signal processing (DSP), analysis, neural-net machine learning, advanced rules engines, for use in a machine learning inference engine at the device.

It will be understood that the specific embodiments of the present invention shown and described herein are exemplary only. Numerous variations, changes, substitutions and equivalents will now occur to those skilled in the art without departing from the spirit and scope of the invention. For example, although embodiments of the invention are described with respect to monitoring and detecting leaks in oil and gas distribution systems, the underlying principles described herein can be used for additional purposes and in additional use cases. For example, systems and methods of the present invention may be utilized to remotely monitor any locations where pressurized fluids are used including, but not limited to, universities, testing facilities, healthcare facilities, aerospace facilities, and chemical engineering facilities.

The electronic devices described herein may include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Additionally, one or more parts of an embodiment of the invention may be implemented using different combinations of software, firmware, and/or hardware.

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. An apparatus, comprising:
a multivariate sensing device to be coupled to a containment asset designed to contain a pressurized fluid, the multivariate sensing device comprising:
a plurality of different types of sensors to provide multivariate sensor data, the plurality of different types of sensors including an accelerometer to capture multi-dimensional vibrational data, one or more microphones to capture audio data, and one or more temperature sensors to capture temperature data;
circuitry to implement a local machine learning (ML) engine operable in accordance with a first ML model to detect leaks of the pressurized fluid from the containment asset based on the multivariate sensor data;
a wireless interface to couple the multivariate sensing device to a cloud-based management service comprising a cloud ML engine operable in accordance with a second ML model to detect leaks of the pressurize fluid with greater accuracy and/or by consuming more power than the local ML engine,
wherein the multivariate sensing device is to transmit a first message via the wireless interface to the cloud-based management service in response to a detected leak by the local ML engine, the cloud ML engine to evaluate the multivariate sensor data based on the second ML model to determine if the multivariate sensor data indicates a leak, wherein if the cloud ML engine determines that the multivariate sensor data does not indicate a leak, then the cloud-based management service is to transmit a second message to the multivariate sensing device indicating that no leak was detected; and
circuitry to train the first ML model based on the second message.

2. The apparatus of claim 1, wherein the circuitry to implement a local ML engine comprises one or both of: a processor to execute program code to implement the local ML engine and dedicated ML circuitry to implement the local ML engine.

3. The apparatus of claim 1, wherein the first ML model is to initially be seeded from a physics model of an environment of the containment asset and/or is to initially be configured using transfer learning based on one or more previously installed ML models.

4. The apparatus of claim 3, wherein the circuitry to train the first ML model is to perform supervised learning using a convolutional neural network (CNN).

5. The apparatus of claim 1, wherein the containment asset comprises a pressurized storage tank and the pressurized fluid comprises pressurized natural gas.

6. The apparatus of claim 1, wherein the wireless interface comprises a cellular data interface to communicate with the cloud-based management service over a cellular network.

7. The apparatus of claim 6, wherein the multivariate sensing device further comprises: a low power local wireless interface to establish communication channels with mobile devices running an application configured to communicate with the multivariate sensing device, the application to be used to provision the multivariate sensing device to communicate with the cloud-based management service and to provide updates to the multivariate sensing device.

8. The apparatus of claim 1 wherein if the cloud ML engine determines that the multivariate sensor data indicates a leak, then the cloud-based management service is to generate notifications of the leak to one or more users and/or to one or more administrator terminals.

9. The apparatus of claim 1, wherein the plurality of sensors further include one or more humidity sensors to capture humidity measurements.

10. The apparatus of claim 1, wherein the multivariate sensing device comprises a mounting element to be affixed to a surface of the containment asset.

11. The apparatus of claim 10, wherein the accelerometer comprises a triaxial accelerometer to capture the multi-dimensional vibrational data through the mounting element.

12. The apparatus of claim 11, wherein the one or more microphones comprise first and second microelectromechanical systems (MEMs) microphones, the first MEMs microphone integral to or directly coupled to the mounting element and the second MEMs microphone positioned further away from the mounting element.

13. The apparatus of claim 12, wherein the multivariate sensing device is to perform differential operations based on audio captured by the first microphone and audio captured by the second microphone to filter out noise.

14. A method, comprising:
configuring a multivariate sensing device on a containment asset, the multivariate sensing device including a first machine learning (ML) model to detect leaks in the containment asset and including a plurality of different types of sensors to provide multivariate sensor data;
establishing a secure communication channel between the multivariate sensing device and a cloud-based management service configured with a cloud ML model to detect leaks in the containment asset;
applying the first ML model to the multivariate sensor data to determine if the containment asset has a leak;
in response to a determination of a leak, transmitting a first message to the cloud-based management service including the multivariate sensor data;
applying the cloud ML model to the multivariate sensor data to determine if the containment asset has a leak; and
in response to determining that the multivariate sensor data does not indicate a leak:
transmitting a second message to the multivariate sensing device indicating that no leak was detected, and
training the first ML model based on the second message.

15. The method of claim 14, wherein the first ML model is implemented with a processor to execute program code and/or dedicated ML circuitry.

16. The method of claim 14, further comprising:
initially seeding the first ML model from a physics model of an environment of the containment asset and/or initially configuring the first ML model using transfer learning based on one or more previously installed ML models.

17. The method of claim 16, wherein first ML model is based on a convolutional neural network (CNN) and is to be trained through supervised learning.

18. The method of claim 14, wherein the containment asset comprises a pressurized storage tank and the pressurized fluid comprises pressurized natural gas.

19. The method of claim 14, wherein establishing the secure communication channel is performed over a cellular data interface.

20. The method of claim 19, wherein the multivariate sensing device further comprises: a low power local wireless interface to establish communication channels with mobile devices running an application configured to communicate with the multivariate sensing device, the application to be used to provision the multivariate sensing device to communicate with the cloud-based management service and to provide updates to the multivariate sensing device.

21. The method of claim 14 wherein if the cloud ML engine determines that the multivariate sensor data indicates a leak, then the cloud-based management service is to generate notifications of the leak to one or more users and/or to one or more administrator terminals.

22. The method of claim 14, wherein the plurality of different types of sensors further include one or more humidity sensors to capture humidity measurements.

23. The method of claim 14, wherein the multivariate sensing device comprises a mounting element, the method further comprising: affixing the mounting element to a surface of the containment asset.

24. The method of claim 23, wherein the a plurality of different types of sensors include a triaxial accelerometer to capture the multi-dimensional vibrational data through the mounting element.

25. The method of claim 24, wherein the plurality of different types of sensors include first and second microelectromechanical systems (MEMs) microphones, the first MEMs microphone integral to or directly coupled to the mounting element and the second MEMs microphone positioned further away from the mounting element.

26. The method of claim 25, wherein the multivariate sensing device is to perform differential operations based on audio captured by the first microphone and audio captured by the second microphone to filter out noise.
